(19) United States
(12) Patent Application Publication
(10) Pub. No.: US 2018/0182056 A1
(43) Pub. Date: Jun. 28, 2018

(54) INFORMATION SENDING AND RECEIVING METHOD AND APPARATUS

(71) Applicant: BEIJING ZHIGU RUI TUO TECH CO., LTD., BEIJING (CN)

(72) Inventor: HANNING ZHOU, BEIJING (CN)

(21) Appl. No.: 15/536,736

(22) PCT Filed: Nov. 20, 2015
(86) PCT No.: PCT/CN2015/095112

§ 371 Date: Jun. 16, 2017

(30) Foreign Application Priority Data
Dec. 18, 2014 (CN) 201410791205.6

(51) Int. Cl. G06T 1/00

(52) U.S. Cl. CPC G06T 1/0021; G06T 2201/0051

(57) ABSTRACT

Embodiments of the present application provide information sending and receiving methods and apparatus. An information sending method disclosed herein comprises: determining to-be-transferred information; determining at least one optical ambiguity function corresponding to the information; processing an original image according to the at least one optical ambiguity function, to obtain a transfer image; and sending the transfer image.

### RELATED APPLICATION

The present international patent cooperative treaty (PCT) application claims priority to and benefit of the Chinese Patent Application No. 201410791205.6, filed on Dec. 18, 2014, and entitled “Information Sending and Receiving Method and Apparatus”, which is herein incorporated into the present international PCT application by reference in its entirety.

### TECHNICAL FIELD

Embodiments of the present application generally relate to the field of communication technologies, and in particular, to information sending and receiving methods and apparatus.

### BACKGROUND

With the popularity of camera features in mobile phones, more and more users now use a mobile phone to take and upload photos. A great number of photos may be used to conceal some important information that is intended to be shared with a specific person, but not intended to be acquired by a third party, such as a user password and bank account information.

### SUMMARY

In view of the above technical problems, a first objective of embodiments of the present application is to provide a solution for sending information.

In view of the above technical problems, a second objective of embodiments of the present application is to provide a solution for receiving information.

To achieve the foregoing first objective, according to a first aspect of the embodiments of the present application, an information sending method is provided, comprising:

determining to-be-transferred information;

determining at least one optical ambiguity function corresponding to the information;

processing an original image according to the at least one optical ambiguity function, to obtain a transfer image; and

sending the transfer image.

To achieve the foregoing second objective, according to a second aspect of the embodiments of the present application, an information receiving method is provided, comprising:

receiving a transfer image;

performing an optical ambiguity function estimation on the transfer image, to obtain at least one optical ambiguity function of the transfer image; and

determining information corresponding to the at least one optical ambiguity function.

To achieve the foregoing first objective, according to a third aspect of the embodiments of the present application, an information sending apparatus is provided, comprising:

a first determining module, configured to determine to-be-transferred information;

a second determining module, configured to determine at least one optical ambiguity function corresponding to the information;

an ambiguity processing module, configured to process an original image according to the at least one optical ambiguity function, to obtain a transfer image; and

a sending module, configured to send the transfer image.

To achieve the foregoing second objective, according to a fourth aspect of the embodiments of the present application, an information receiving apparatus is provided, comprising:

a receiving module, configured to receive a transfer image;

an estimation module, configured to perform an optical ambiguity function estimation on the transfer image, to obtain at least one optical ambiguity function of the transfer image; and

a determining module, configured to determine information corresponding to the at least one optical ambiguity function.

At least one of the above multiple technical solutions has the following beneficial effects:

According to the embodiments of the present application, at least one optical ambiguity function corresponding to to-be-transferred information is determined, and according to the at least one optical ambiguity function, an original image is processed, to obtain a transfer image and send the transfer image, thus providing a solution for sending information. Moreover, the information is concealed in the transfer image and only user(s) who knows how the information corresponds to the optical ambiguity function can obtain the concealed information from the transfer image, thus improving security and privacy of information sharing.

### BRIEF DESCRIPTION OF THE DRAWINGS

FIG. 1A is a schematic flowchart of an embodiment of an information sending method according to the present application;

FIG. 1B is a schematic diagram of four optical ambiguity functions comprised in a corresponding relationship according to the present application;

FIG. 2 is a schematic flowchart of an embodiment of an information receiving method according to the present application;

FIG. 3A is a schematic structural diagram of embodiment 1 of an information sending apparatus according to the present application;

FIG. 3B to FIG. 3F are separately a schematic structural diagram of an implementation manner of the embodiment shown in FIG. 3A;

FIG. 4A is a schematic structural diagram of embodiment 1 of an information receiving apparatus according to the present application;

FIG. 4B to FIG. 4F are separately a schematic structural diagram of an implementation manner of the embodiment shown in FIG. 4A;

FIG. 5 is a schematic structural diagram of embodiment 2 of an information sending apparatus according to the present application; and

FIG. 6 is a schematic structural diagram of embodiment 2 of an information receiving apparatus according to the present application.

### DETAILED DESCRIPTION

The following further describes specific implementations of the present application in detail with reference to the accompanying drawings and embodiments. The following embodiments are intended to illustrate the present application, but are not intended to limit the scope of the present application.

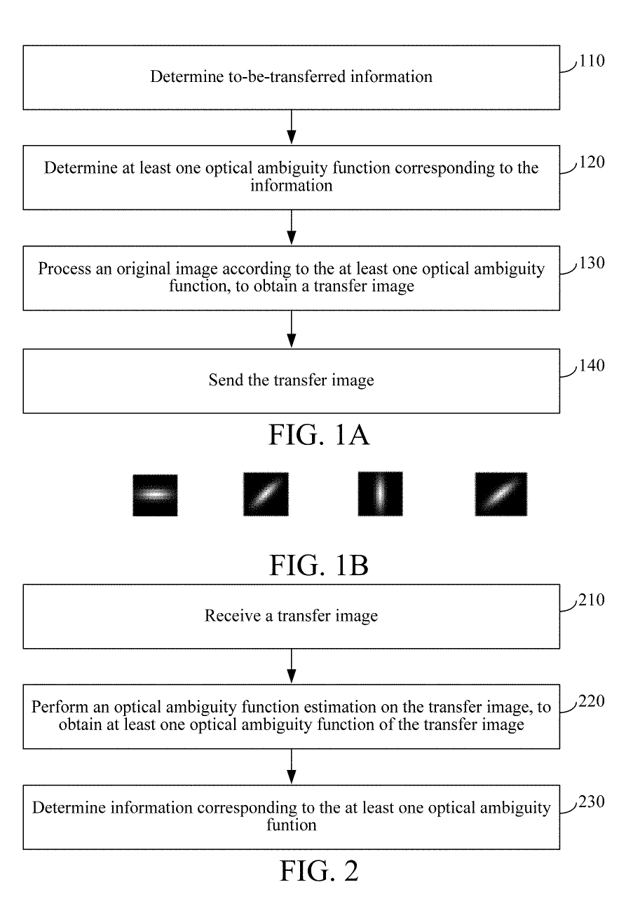

FIG. 1A is a schematic flowchart of an embodiment of an information sending method according to the present application. As shown in FIG. 1A, this embodiment comprises:

110: Determine to-be-transferred information.

For example, an information sending apparatus in embodiment 1 or embodiment 2 of an information sending apparatus according to the present application, can act as an executive body of this embodiment, and perform steps 110 to 140. Specifically, the information sending apparatus may be optionally disposed in a user terminal in a form of software and/or hardware. The user terminal may be, but is not limited to any one of the following: a mobile phone, a computer, and the like.

120: Determine at least one optical ambiguity function corresponding to the information.

In this embodiment, each of the at least one optical ambiguity function is function configured to perform optical ambiguity processing on an image, and each of the at least one optical ambiguity function represents an optical ambiguity processing manner. It should be noted that, each of the at least one optical ambiguity function is estimable. That is, after an image is processed by using an optical ambiguity function, an optical ambiguity function estimation can be performed on the processed image, so as to obtain the optical ambiguity function.

Specifically, the at least one optical ambiguity function may include any one of the following: at least one PSF (Point Spread Function), and at least one OTF (Optical Transfer Function). The PSF is an optical ambiguity function in a space domain form, and the OTF is an optical ambiguity function in a frequency domain form.

130: Process an original image according to the at least one optical ambiguity function, to obtain a transfer image.

In this embodiment, the transfer image is an image obtained after at least one optical ambiguity function processing represented by the at least one optical ambiguity function is performed on the original image.

Specifically, when an optical ambiguity function is a PSF, the an original image is processed according to the PSF, specifically, a convolution operation is performed on a space domain signal of the original image with the PSF; when an optical ambiguity function is an OTF, the an original image is processed according to the OTF, specifically, a multiplication operation is performed on a frequency domain signal of the original image with the OTF.

For example, an original image is represented by f(x, y) in a space domain, and is represented by F(u, v) in a frequency domain; an optical ambiguity function is a PSF and is represented by h(x, y); a transfer image obtained after the original image is processed by using the optical ambiguity function is represented by g(x, y) in a space domain, and is represented by G(u, v) in a frequency domain; and therefore, the following is met: g(x, y)=h(x, y)*f(x, y), wherein * represents a convolution, because a convolution in space domain is equal to a product in frequency domain, a Fourier transform is performed on the above expression, it may be obtained that G(u,v)=H(u,v)F(u,v), wherein H(u,v) is a frequency domain form of the PSF, and is an OTF.

In this embodiment, the original image, optionally, is an image shot with a small aperture. The small aperture refers to an aperture size in the case that an aperture F value of a lens of a 35 mm camera with a focal length of 50 mm is not smaller than 8, or an equivalent aperture F value of a lens of another specification is not smaller than 8 after equivalent conversion. In a scenario in which the original image is an image shot with a small aperture, a PSF during shooting of the original image approximates to an impulse function. Because a convolution result of an impulse function and any PSF is equal to the PSF, correspondingly, when a convolution operation is performed on the original image with a PSF, the PSF during shooting of the original image has a relatively small effect on the result of the convolution.

140: Send the transfer image.

In this embodiment, there are various sending manners, for example, the transfer image is sent to at least one receiver through e-mail, the transfer image is published in a social network, or the transfer image is sent to at least one terminal in a wireless local area network by using a wireless communication technology, or the like.

It should be noted that, an executive body of this embodiment acts as an information sender, and a corresponding information receiver may be the information receiving apparatus in embodiment 1 or embodiment 2 of an information receiving apparatus according to the present application.

According to this embodiment, at least one optical ambiguity function corresponding to to-be-transferred information is determined, and according to the at least one optical ambiguity function, an original image is processed, to obtain a transfer image, thus providing a solution for sending information. Moreover, the information is concealed in the transfer image and only user(s) who knows how the information corresponds to the optical ambiguity function can obtain the concealed information from the transfer image, thus improving security and privacy of information sharing.

The following further describes the method in this embodiment by using some optional implementation manners.

In this embodiment, there are multiple manners of implementing the step 120.

In an optional implementation manner, the information is embedded in at least one character; and correspondingly, the determining at least one optical ambiguity function corresponding to the information comprises:

determining, according to a preset corresponding relationship, at least one optical ambiguity function corresponding to the at least one character.

The at least one character may include, but is not limited to at least one of the following: at least one alphabet letter, at least one number, at least one Chinese character, at least one symbol, and the like.

In the corresponding relationship, optionally, one character corresponds to one optical ambiguity function, or multiple characters correspond to one optical ambiguity function, or one character corresponds to multiple optical ambiguity functions. For example, one character “A” corresponds to optical ambiguity function 1, two characters “BC” correspond to optical ambiguity function 2, and one character “D” corresponds to optical ambiguity function 3 and optical ambiguity function 4.

FIG. 1B is a schematic diagram of four optical ambiguity functions comprised in a corresponding relationship according to the present application. All the four optical ambiguity functions shown in FIG. 1B are PSFs.

In a scenario in which one character corresponds to one optical ambiguity function, the determining, according to a preset corresponding relationship, at least one optical ambiguity function corresponding to the at least one character comprises: determining, according to the corresponding relationship, at least one optical ambiguity function that is in one-to-one corresponding relationship with the at least one character.

In a scenario in which the determined at least one optical ambiguity function in step 120 is multiple optical ambiguity functions, optionally, the multiple optical ambiguity functions may be in a certain order. For example, two optical ambiguity functions corresponding to one character “D” are sequentially as follows: optical ambiguity function 3 and optical ambiguity function 4; and two optical ambiguity functions corresponding to two characters “EF” are sequentially as follows: optical ambiguity function 4 and optical ambiguity function 3. It can be seen that, one character “D” and two characters “EF” correspond to two same optical ambiguity functions, but an order of the two optical ambiguity functions corresponding to one character “D” is different from an order of the two optical ambiguity functions corresponding to two characters “EF”.

Further, optionally, the at least one character is multiple characters. The multiple optical ambiguity functions determined in the step 120 comprise at least one optical ambiguity function corresponding to each of the multiple characters. Correspondingly, an order of the at least one optical ambiguity function corresponding to each of the multiple characters is corresponding to an order of the multiple characters. Following the above example, if the information is carried in four characters “ABCD”, the multiple optical ambiguity functions determined in the step 120 are sequentially as follows: optical ambiguity function 1, optical ambiguity function 2, optical ambiguity function 3, and optical ambiguity function 4; and if the information is carried in four characters “ADBC”, the multiple optical ambiguity functions determined in the step 120 are sequentially as follows: optical ambiguity function 1, optical ambiguity function 3, optical ambiguity function 4, and optical ambiguity function 2.

In this embodiment, there are multiple manners of implementing the step 130.

In an optional implementation manner, the processing an original image according to the at least one optical ambiguity function, to obtain a transfer image comprises:

selecting at least one first region from the original image;

separately processing the at least one first region by respectively using the at least one optical ambiguity function, to obtain at least one second region; and

replacing the at least one first region in the original image with the at least one second region, to obtain the transfer image.

Specifically, the number of the selected at least one first region may be the same with the number of the at least one optical ambiguity function determined in the step 120. Correspondingly, the at least one optical ambiguity function is in one-to-one corresponding relationship with the at least one first region, and one optical ambiguity function is configured to process one first region, to obtain one second region.

Specifically, when the selected at least one first region is multiple first regions, the multiple first regions are multiple parts that do not overlap with each other in the original image; and when the selected at least one first region is one first region, the first region may be the whole of the original image, or any part of the original image.

In this implementation manner, optionally, the selecting at least one first region from the original image comprises:

dividing the original image into M first region(s), wherein M is a natural number; and

selecting N first region(s) from the M first region(s), wherein N is a natural number equal to or less than M.

There are many division manners in which the original image is divided into M first region(s). Optionally, the division manner is set in advance, or determined according to the number of the at least one optical ambiguity function determined in the step 120. For example, the division manner may be dividing the original image equally according to a certain size, wherein the certain size, for example, may be 100 pixels*100 pixels; or the division manner may be a division manner based on clustering, a division manner based on color similarity, a division manner based on object edge, or a division manner based on Graph-cut algorithm.

There are many selection manners in which N first region(s) is/are selected from the M first region(s). Optionally, the selection manner is set in advance, or determined according to the number of the at least one optical ambiguity function determined in the step 120. For example, the selection manner may be selecting one first region every two first regions from up to down and from left to right according to position(s) of the M first region(s) in the original image, or the selection manner may be selecting from the original image at least one first region that is at the edge.

Correspondingly, in a scenario in which the foregoing division manner and the foregoing selection manner are set in advance, the number of the selected at least one first region and the position of the at least one first region in the original image may also be predictable.

Further, optionally, the selecting N first region(s) from the M first region(s), wherein N is a natural number equal to or less than M comprises:

performing visual significance detection on the original image, to obtain visual significance of the M first region(s); and

selecting the N first region(s) from P first region(s) of which visual significance is not larger than a significance threshold, wherein P is a natural number equal to or greater than N.

There may be many manners of detecting visual significance, for example, a from-bottom-to-top detection method, a from-top-to-down detection method, and the like. Specifically, the from-bottom-to-top detection method is based on at least one feature of the bottom, for example, color, edge, texture, and/or the like; and the from-top-to-down detection method is driven by a task or purpose, such as, human face detection.

Specifically, because visual significance of the N first region(s) is not larger than the significance threshold, it is more difficult for a user to perceive the optical ambiguity processing performed on the N first region(s) with naked eye.

For example, four optical ambiguity functions are determined in the step 120, and in the step 130, the original image is divided into 10 first regions equally, wherein visual significance of 6 first regions is not larger than the significance threshold. Correspondingly, 4 first regions are selected from the 6 first regions, and the 4 first regions are processed by respectively using the 4 optical ambiguity functions determined in the step 120, to obtain 4 second regions.

In this implementation manner, optionally, there is a certain order existing in the selected multiple first regions in the original image, from example, from up to down and from left to right. If multiple optical ambiguity functions are determined in the step 120 and the multiple optical ambiguity functions are in a certain order, when the multiple first regions are respectively processed by using the multiple optical ambiguity functions, one first region is processed by using an corresponding optical ambiguity function the precedence of which in the multiple optical ambiguity function is in accordance with the precedence of the first region in the multiple first regions. For example, the multiple optical ambiguity functions determined in the step 120 are sequentially as follows: optical ambiguity function 1, optical ambiguity function 2, optical ambiguity function 3, and optical ambiguity function 4; and from up to down and from left to right in the original image, the multiple first regions selected in the step 130 are sequentially as follows: first region A, first region B, first region C, and first region D. Correspondingly, the first region A is processed by using the optical ambiguity function 1, to obtain second region A; the first region B is processed by using the optical ambiguity function 2, to obtain second region B; the first region C is processed by using the optical ambiguity function 3, to obtain second region C; the first region D is processed by using the optical ambiguity function 4, to obtain second region D; and then, the first regions A to D in the original image are separately replaced with the second regions A to D, to obtain the transfer image.

In another optional implementation manner, the processing an original image according to the at least one OTF, to obtain a transfer image comprises:

selecting at least one first channel from the original image;

processing the at least one first channel by respectively using the at least one optical ambiguity function, to obtain at least one second channel; and

replacing the at least one first channel in the original image with the at least one second channel, to obtain the transfer image.

In this implementation manner, optionally, the original image comprises multiple channels. For example, in an R(Red)G(Green)B(Blue) mode, the original image usually comprises three color channels: R, G, and B. In a hyperspectral mode, the original image usually comprises tens to hundreds of color channels. Besides the foregoing color channels, optionally, the original image further comprises at least one other channel, for example, a depth channel. It should be noted that, any channel of the original image, actually, also is an image.

Specifically, selecting at least one first channel from the original image refers to selecting at least one channel from the multiple channels of the original image as the at least one first channel.

In this implementation manner, optionally, the number of the at least one first channel selected is the same with the number of the at least one optical ambiguity function determined in the step 120. Correspondingly, the at least one optical ambiguity function is in one-to-one corresponding relationship with the at least one first channel, and one optical ambiguity function is configured to process one first channel, to obtain one second channel.

In this implementation manner, optionally, the processing the at least one first channel by respectively using the at least one optical ambiguity function, to obtain at least one second channel comprises:

selecting at least one first sub-region from the at least one first channel;

processing the at least one first sub-region by respectively using the at least one optical ambiguity function, to obtain at least one second sub-region; and

replacing the at least one first sub-region in the at least one first channel respectively with the at least one second sub-region, to obtain at least one second channel.

Specifically, the number of the at least one first sub-region selected is the same with the number of the at least one optical ambiguity function determined in the step 120. Correspondingly, the at least one optical ambiguity function is in one-to-one corresponding relationship with the at least one first sub-region, and one optical ambiguity function is configured to process one first sub-region, to obtain one second sub-region.

Specifically, when multiple first sub-regions are selected from a first channel, the multiple first sub-regions are multiple parts that do not overlap with each other in the first channel; and when one first sub-region is selected from a first channel, the first sub-region may be the whole of the first channel, or any part of the first channel.

In this implementation manner, there are many manners in which at least one first sub-region is selected from the at least one first channel. For example, each of the at least one first channel may be divided into at least one first sub-region, and then, the at least one first sub-region is selected from all first sub-regions obtained by dividing the first channels, wherein manners of dividing the first channels may be the same or different. For example, the original image may be divided into M first region(s), wherein M is a natural number. Correspondingly, the at least one first channel selected all are divided into M first sub-region(s), and then, the at least one first sub-region is selected from all first sub-regions obtained by dividing all the first channels.

For the foregoing manners of dividing each of the at least one first channel and dividing the original image, optionally, reference may be made to the manner of dividing the original image in the implementation manners as discussed above.

There are many selection manners in which the at least one first sub-region is selected from all first sub-regions obtained by dividing the at least one first channel. Optionally, reference may be made to a manner in which N first region(s) is/are selected from the M first region(s) in the implementation manners as discussed above.

FIG. 2 is a schematic flowchart of an embodiment of an information receiving method according to the present application. As shown in FIG. 2, this embodiment comprises:

210: Receive a transfer image.

For example, an information receiving apparatus in embodiment 1 or embodiment 2 of an information receiving apparatus according to the present application, can act as an executive body of this embodiment to perform steps 210 to 230. Specifically, the information receiving apparatus may be optionally disposed in a user terminal in a form of software and/or hardware. The user terminal may be, but is not limited to any one of the following: a mobile phone, a computer, and the like.

220: Perform an optical ambiguity function estimation on the transfer image, to obtain at least one optical ambiguity function of the transfer image.

In this embodiment, each of the at least one optical ambiguity function is function configured to perform optical ambiguity processing on an image, and each of the at least one optical ambiguity function represents an optical ambiguity processing manner. It should be noted that, each of the at least one optical ambiguity function is estimable. That is, after an image is processed by using an optical ambiguity function, an optical ambiguity function estimation can be performed on the processed image, so as to obtain the optical ambiguity function.

Specifically, the at least one optical ambiguity function comprises any one of the following: at least one PSF, and at least one OTF. The PSF is an optical ambiguity function in a space domain form, and the OTF is an optical ambiguity function in a frequency domain form.

Correspondingly, the performing an optical ambiguity function estimation on the transfer image, to obtain at least one optical ambiguity function of the transfer image comprises:

performing a PSF estimation on the transfer image, to obtain at least one PSF of the transfer image; or

performing an OTF estimation on the transfer image, to obtain at least one OTF of the transfer image.

In this embodiment, the transfer image is an image obtained after at least one optical ambiguity function processing represented by the at least one optical ambiguity function is performed on an original image. Specifically, when an optical ambiguity function is a PSF, the optical ambiguity processing is performed on an original image specifically comprises: a convolution operation is performed on a space domain signal of the original image with the PSF; when an optical ambiguity function is an OTF, the optical ambiguity processing is performed on an original image specifically comprises: a multiplication operation is performed on a frequency domain signal of the original image with the OTF.

The original image, optionally, is an image shot with a small aperture. The small aperture refers to an aperture size in the case that an aperture F value of a 35 mm camera with a focal length of 50 mm is not smaller than 8, or an equivalent aperture F value of a lens of another specification being not smaller than 8 after an equivalent conversion. In a scenario in which the original image is an image shot with a small aperture, a PSF during shooting of the original image approximates to an impulse function. Because a convolution result of an impulse function and any PSF is equal to the PSF, correspondingly, when a convolution operation is performed on the original image with a PSF, the PSF during shooting of the original image has a relatively small effect on a convolution result.

230: Determine information corresponding to the at least one optical ambiguity function.

In this embodiment, the information corresponding to the at least one optical ambiguity function is information to be transferred by the transfer image, that is, information that is concealed in the transfer image.

It should be noted that, an executive body of this embodiment is used as an information receiver, and a corresponding information sender may be the information sending apparatus in embodiment 1 or embodiment 2 of an information sending apparatus according to the present application.

According to this embodiment, a transfer image is received, an optical ambiguity function estimation is performed on the transfer image, to obtain at least one optical ambiguity function of the transfer image, and information corresponding to the at least one optical ambiguity function is determined, thus providing a solution for receiving information. Moreover, the information is concealed in the transfer image and only user(s) who knows how the information corresponds to the optical ambiguity function can obtain the concealed information from the transfer image, thus improving security and privacy of information sharing.

The following further describes the method in this embodiment by using some optional implementation manners.

In this embodiment, there are multiple manners of implementing the step 220.

In an optional implementation manner, the performing an optical ambiguity function estimation on the transfer image, to obtain at least one optical ambiguity function of the transfer image comprises:

selecting at least one region from the transfer image; and

separately performing an optical ambiguity function estimation on the at least one region, to obtain the at least one optical ambiguity function.

Specifically, the at least one optical ambiguity function is in one-to-one corresponding relationship with the at least one region, that is, an optical ambiguity function estimation is performed on one region, to obtain one optical ambiguity function.

Specifically, when the selected at least one region is multiple regions, the multiple regions are multiple parts that do not overlap with each other in the transfer image; and when the selected at least one region is one region, the region may be the whole of the transfer image, or any part of the transfer image.

In this implementation manner, optionally, the selecting at least one region from the transfer image comprises:

dividing the transfer image into M region(s), wherein M is a natural number; and

selecting N region(s) from the M region(s), wherein N is a natural number equal to or less than M.

There are many division manners in which the original image is divided into M region(s). Optionally, the division manner is set in advance. For example, the division manner may be dividing the original image equally according to a certain size, wherein the certain size, for example, may be 100 pixels*100 pixels; or the division manner may be a division manner based on clustering, a division manner based on color similarity, a division manner based on object edge, or a division manner based on Graph-cut algorithm.

There are many selection manners in which N region(s) is/are selected from the M region(s). Optionally, the selection manner is set in advance. For example, the selection manner may be selecting one region every two regions from up to down and from left to right according to position(s) of the M region(s) in the transfer image, or the selection manner may be selecting from the transfer image at least one region that is at the edge.

Correspondingly, in a scenario in which the foregoing division manner and the foregoing selection manner are set in advance, the number of the selected at least one region and position(s) of the at least one region in the transfer image may be predictable.

Further, optionally, the selecting N region(s) from the M region(s) comprises:

performing visual significance detection on the transfer image, to obtain visual significance of the M region(s); and

selecting the N region(s) from P region(s) of which visual significance is not larger than a significance threshold, wherein P is a natural number equal to or greater than N.

There may be many manners of detecting visual significance, for example, a from-bottom-to-top detection method, a from-top-to-down detection method, and the like. Specifically, the from-bottom-to-top detection method is based on at least one feature of the bottom, for example, color, edge, texture, and/or the like; and the from-top-to-down detection method is driven by a task or purpose, such as, human face detection.

Specifically, for an information sender, optionally, optical ambiguity processing is performed on a low-visual-significance region selected from the original image so that the optical ambiguity processing is difficult to be perceived by a user with naked eye. Further, visual significance of the region on which the optical ambiguity processing is performed usually becomes lower.

For example, the transfer image is divided into 10 regions equally, wherein visual significance of 6 regions is not larger than the significance threshold. Correspondingly, 4 regions are selected from the 6 regions, and optical ambiguity function estimations are separately performed on the 4 regions, to obtain 4 optical ambiguity functions.

In this implementation manner, optionally, there is a certain order existing in the selected multiple regions in the transfer image, from example, from up to down and from left to right. Correspondingly, the multiple optical ambiguity functions obtained in the step 220 are also in a certain order, and this order is consistent with an order of the multiple regions in the transfer image. For example, from up to down and from left to right in the transfer image, the selected multiple regions are sequentially as follows: region A, region B, region C, and region D. An optical ambiguity function estimation is performed on the region A, to obtain optical ambiguity function 1; an optical ambiguity function estimation is performed on the region B, to obtain optical ambiguity function 2; an optical ambiguity function estimation is performed on the region C, to obtain optical ambiguity function 3; and an optical ambiguity function estimation is performed on the region D, to obtain optical ambiguity function 4. Correspondingly, multiple optical ambiguity functions finally obtained in the step 220 are sequentially as follows: optical ambiguity function 1, optical ambiguity function 2, optical ambiguity function 3, and optical ambiguity function 4.

In another optional implementation manner, the performing an optical ambiguity function estimation on the transfer image, to obtain at least one optical ambiguity function of the transfer image comprises:

selecting at least one channel from the transfer image; and

performing an optical ambiguity function estimation on the at least one channel, to obtain the at least one optical ambiguity function.

In this implementation manner, optionally, the transfer image comprises multiple channels. For example, in an RGB mode, the transfer image usually comprises three color channels: R, G, and B. In a hyperspectral mode, the transfer image usually comprises tens to hundreds of color channels. Besides the foregoing color channels, optionally, the transfer image further comprises at least one another channel, for example, a depth channel. It should be noted that, any channel of the transfer image, actually, also is an image.

In this implementation manner, optionally, the at least one optical ambiguity function is in one-to-one corresponding relationship with the at least one channel, that is, an optical ambiguity function estimation is performed on one channel, to obtain one optical ambiguity function.

In this implementation manner, optionally, the performing an optical ambiguity function estimation on the at least one channel, to obtain the at least one optical ambiguity function comprises:

selecting at least one sub-region from the at least one channel; and

performing an optical ambiguity function estimation on the at least one sub-region, to obtain the at least one optical ambiguity function.

Specifically, the at least one optical ambiguity function is in one-to-one corresponding relationship with the at least one sub-region, that is, an optical ambiguity function estimation is performed on one sub-region, to obtain one optical ambiguity function.

Specifically, when multiple sub-regions are selected from a channel, the multiple sub-regions are multiple parts that do not overlap with each other in the channel; and when one sub-region is selected from a channel, the sub-region may be the whole of the channel, or any part of the channel.

In this implementation manner, there are many manners in which at least one sub-region is selected from the at least one channel. For example, each of the selected at least one channels may be divided into at least one sub-region, and then, the at least one sub-region is selected from all sub-regions obtained by dividing the selected at least one channel, wherein manners of dividing the at least one channel may be the same or different. For example, the transfer image may be divided into M region(s), wherein M is a natural number. Correspondingly, each of the selected at least one channel is divided into M sub-region(s), and then, the at least one sub-region is selected from all sub-regions obtained by dividing all the selected at least one channel.

For the foregoing manners of dividing the selected at least one channel and the transfer image, optionally, reference may be made to the manner of dividing the transfer image in the implementation manners as discussed above.

There are many selection manners in which the at least one sub-region is selected from all sub-regions obtained by dividing the selected at least one channels Optionally, reference may be made to a manner in which N region(s) is/are selected from the M region(s) in the implementation manners discussed above.

In this embodiment, there are multiple manners of implementing the step 230.

In an optional implementation manner, the information is carried in at least one character; and correspondingly, the determining information corresponding to the at least one optical ambiguity function comprises:

determining, according to a preset corresponding relationship, the at least one character corresponding to the at least one optical ambiguity function.

The at least one character comprises, but is not limited to at least one of the following: at least one alphabetical letter, at least one number, at least one Chinese character, at least one symbol, and the like.

In the corresponding relationship, optionally, one optical ambiguity function corresponds to one character, or one optical ambiguity function corresponds to multiple characters, or multiple optical ambiguity functions correspond to one character. For example, optical ambiguity function 1 corresponds to one character “A”, optical ambiguity function 2 corresponds to two characters “BC”, and optical ambiguity function 3 and optical ambiguity function 4 correspond to a character “D”.

FIG. 1B is a schematic diagram of four optical ambiguity functions comprised in a corresponding relationship according to the present application. All the four optical ambiguity functions shown in FIG. 1B are PSFs.

Specifically, the at least one optical ambiguity function obtained in the step 220 may not be completely consistent with optical ambiguity functions that are in the corresponding relationship. Optionally, the determining, according to a preset corresponding relationship, the at least one character corresponding to the at least one optical ambiguity function comprises:

based on each of the at least one optical ambiguity function, determining that at least one character corresponding to the optical ambiguity function is at least one character corresponding to an optical ambiguity function in the corresponding relationship that is most highly similar to the optical ambiguity function.

In a scenario in which one optical ambiguity function corresponds to one character, the determining, according to a preset corresponding relationship, the at least one character corresponding to the at least one optical ambiguity function comprises:

determining, according to the corresponding relationship, the at least one character that is in one-to-one corresponding relationship with the at least one optical ambiguity function.

In a scenario in which the information is carried in multiple characters, there is a certain order existing in the multiple characters. Optionally, if the multiple characters include at least one character corresponding to each of the multiple optical ambiguity functions that are obtained in the step 220, an order between at least one character corresponding to each of the multiple optical ambiguity functions is corresponding to an order in the multiple optical ambiguity functions. Following the above example, if multiple optical ambiguity functions determined in the step 220 are sequentially as follows: optical ambiguity function 1, optical ambiguity function 2, optical ambiguity function 3, and optical ambiguity function 4, four characters determined in the step 230 are “ABCD”; and if the multiple optical ambiguity functions determined in the step 220 are sequentially as follows: optical ambiguity function 1, optical ambiguity function 3, optical ambiguity function 4, and optical ambiguity function 2, four characters determined in the step 230 are “ADBC”.

An application scenario of the present application is as follows: information that user A wants to share with user B is concealed in the transfer image by using the method of an embodiment of an information sending method according to the present application, and the transfer image is published. Based on the knowledge about the corresponding relationship in the embodiments of an information sending method according to the present application, the user B may acquire the information from the transfer image by using the method in an embodiment of an information receiving method according to the present application.

However, other users who do not know the corresponding relationship cannot acquire the information from the transfer image.

Another application scenario of the present application is as follows: user A wants to share an original image with user B, user C, and user D, but do not want the original image to be leaked. The user A may conceal three sorts of information respectively in three transfer images by using the method in an embodiment of an information sending method according to the present application, and respectively shares the three transfer images with the user B, user C, and user D. When finding that a transfer image is leaked, the user A may acquire from the leaked transfer image the information that is concealed in the transfer image by using the method in an embodiment of an information receiving method according to the present application, thus knowing which one of the user B, user C, user D leaks the transfer image.

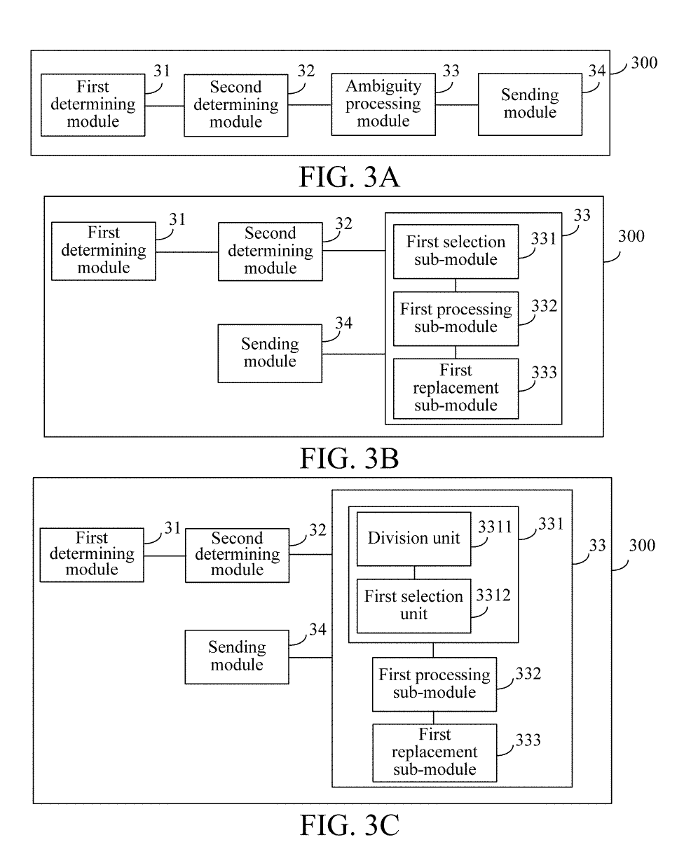

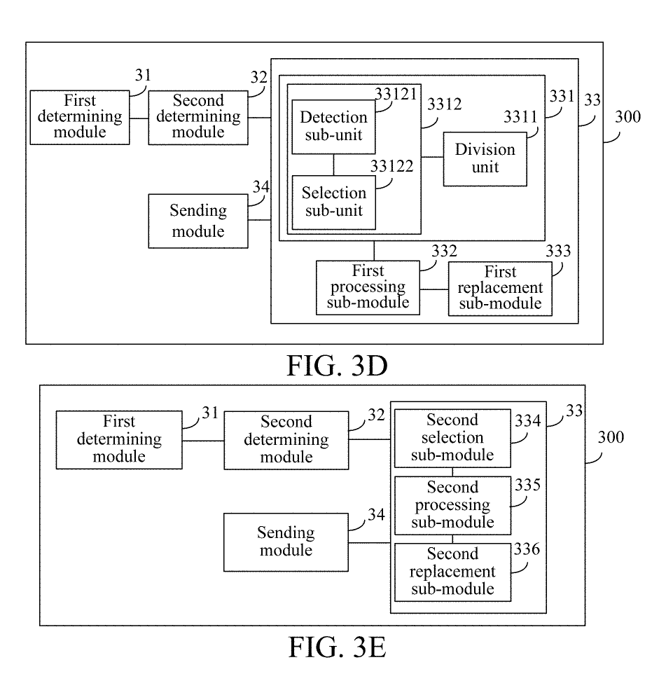

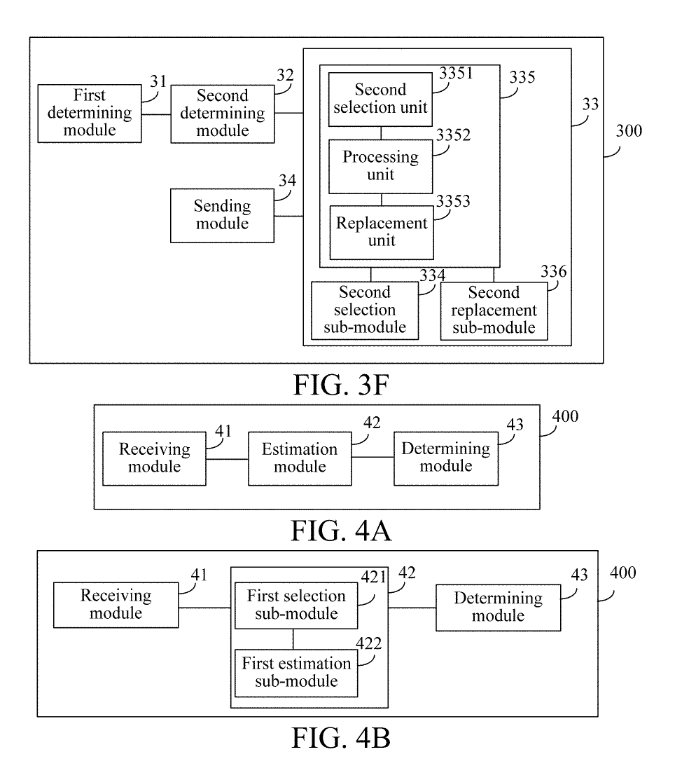

FIG. 3A is a schematic structural diagram of embodiment 1 of an information sending apparatus according to the present application. As shown in FIG. 3A, an information sending apparatus (apparatus for short below) 300 comprises:

a first determining module 31, configured to determine to-be-transferred information;

a second determining module 32, configured to determine at least one optical ambiguity function corresponding to the information;

a ambiguity processing module 33, configured to process an original image according to the at least one optical ambiguity function, to obtain a transfer image; and

a sending module 34, configured to send the transfer image.

In this embodiment, the information sending apparatus 300 may be optionally disposed in a user terminal in a form of software and/or hardware. The user terminal may be, but is not limited to any one of the following: a mobile phone, a computer, and the like.

In this embodiment, each of the at least one optical ambiguity function is function configured to perform optical ambiguity processing on an image, and each of the at least one optical ambiguity function represents an optical ambiguity processing manner. It should be noted that, each of the at least one optical ambiguity function is estimable. That is, after an image is processed by using an optical ambiguity function, an optical ambiguity function estimation can be performed on the processed image, so as to obtain the optical ambiguity function.

Specifically, the at least one optical ambiguity function comprises any one of the following: at least one PSF, and at least one OTF. The PSF is an optical ambiguity function in a space domain form, and the OTF is an optical ambiguity function in a frequency domain form.

In this embodiment, the transfer image is an image obtained after at least one optical ambiguity function processing represented by the at least one optical ambiguity function is performed on the original image.

Specifically, when an optical ambiguity function is a PSF, an original image is processed according to the PSF, specifically, a convolution operation is performed on a space domain signal of the original image with the PSF. When an optical ambiguity function is an OTF, an original image is processed according to the OTF, specifically, a multiplication operation is performed on a frequency domain signal of the original image by using the OTF.

For example, an original image is represented by f(x, y) in a space domain, and is represented by F(u, v) in a frequency domain; an optical ambiguity function is a PSF and is represented by h(x, y); a transfer image obtained after the original image is processed by using the optical ambiguity function is represented by g(x, y) in a space domain, and is represented by G(u, v) in a frequency domain; and therefore, the following is met: g(x, y)=h(x, y)*f(x, y), wherein * represents a convolution, because a convolution in space domain is equal to a product in frequency domain, a Fourier transform is performed on the expression, it may be obtained that G(u,v)=H(u,v)F(u,v), wherein H(u,v) is a frequency domain form of the PSF, and is an OTF.

In this embodiment, the original image, optionally, is an image shot with a small aperture. The small aperture refers to an aperture size in the case that an aperture F value of a lens of a 35 mm camera with a focal length of 50 mm is not smaller than 8, or an equivalent aperture F value of a lens of another specification being not smaller than 8 after equivalent conversion. In a scenario in which the original image is an image shot with a small aperture, a PSF during shooting of the original image approximates to an impulse function. Because a convolution result of an impulse function and any PSF is equal to the PSF, correspondingly, when a convolution operation is performed on the original image with a PSF, the PSF during shooting of the original image has a relatively small effect on a convolution result.

In this embodiment, there may be various manners in which the sending module 34 sends the transfer image, for example, the sending module 34 sends the transfer image to at least one receiver through e-mail, publishes the transfer image in a social network, or sends the transfer image to at least one terminal in a wireless local area network by using a wireless communication technology, or the like.

It should be noted that, the information sending apparatus 300 in this embodiment acts as an information sender, and a corresponding information receiver may be the information receiving apparatus in embodiment 1 or embodiment 2 of an information receiving apparatus according to the present application.

According to this embodiment, the information sending apparatus determines at least one optical ambiguity function corresponding to to-be-transferred information, and according to the at least one optical ambiguity function, processes an original image, to obtain a transfer image and method, thus providing a solution for sending information. Moreover, the information is concealed in the transfer image and only user(s) who knows how the information corresponds to the optical ambiguity function can obtain the concealed information from the transfer image, thus improving security and privacy of information sharing.

The following further describes the apparatus 300 in this embodiment by using some optional implementation manners.

In this embodiment, there are multiple implementation manners for the second determining module 32.

In an optional implementation manner, the information is carried in at least one character; and correspondingly, the second determining module 32 is specifically configured to determine, according to a preset corresponding relationship, at least one optical ambiguity function corresponding to the at least one character.

The at least one character comprises, but is not limited to at least one of the following: at least one alphabetical letter, at least one number, at least one Chinese character, at least one symbol, and the like.

In the corresponding relationship, optionally, one character corresponds to one optical ambiguity function, or multiple characters correspond to one optical ambiguity function, or one character corresponds to multiple optical ambiguity functions. For example, one character “A” corresponds to optical ambiguity function 1, two characters “BC” correspond to optical ambiguity function 2, and one character “D” corresponds to optical ambiguity function 3 and optical ambiguity function 4.

FIG. 1B is a schematic diagram of four optical ambiguity functions comprised in a corresponding relationship according to the present application. All the four optical ambiguity functions shown in FIG. 1B are PSFs.

In a scenario in which one character corresponds to one optical ambiguity function, the second determining module 32 is specifically configured to determine, according to the corresponding relationship, at least one optical ambiguity function that is in one-to-one corresponding relationship with the at least one character.

In a scenario in which the at least one optical ambiguity function determined by the second determining module 32 is multiple optical ambiguity functions, optionally, the multiple optical ambiguity functions must be in a certain order. For example, two optical ambiguity functions corresponding to one character “D” are sequentially as follows: optical ambiguity function 3 and optical ambiguity function 4; and two optical ambiguity functions corresponding to two characters “EF” are sequentially as follows: optical ambiguity function 4 and optical ambiguity function 3. It can be seen that, one character “D” and two characters “EF” correspond to two same optical ambiguity functions, but an order of the two optical ambiguity functions corresponding to one character “D” is different from an order of the two optical ambiguity functions corresponding to two characters “EF”.

Further, optionally, the at least one character is multiple characters. The multiple optical ambiguity functions determined by the second determining module 32 comprise at least one optical ambiguity function separately corresponding to each of the multiple characters. Correspondingly, an order of the at least one optical ambiguity function separately corresponding to each of the multiple characters is corresponding to an order of the multiple characters. Following the above example, if the information determined by the first determining module 31 is carried in four characters “ABCD”, the multiple optical ambiguity functions determined by the second determining module 32 are sequentially as follows: optical ambiguity function 1, optical ambiguity function 2, optical ambiguity function 3, and optical ambiguity function 4; and if the information determined by the first determining module 31 is carried in four characters “ADBC”, the multiple optical ambiguity functions determined by the second determining module 32 are sequentially as follows: optical ambiguity function 1, optical ambiguity function 3, optical ambiguity function 4, and optical ambiguity function 2.

In this embodiment, there are multiple implementation manners for the ambiguity processing module 33.

In an optional implementation manner, as shown in FIG. 3B, the ambiguity processing module 33 comprises:

a first selection sub-module 331, configured to select at least one first region from the original image;

a first processing sub-module 332, configured to separately process the at least one first region by using the at least one optical ambiguity function, to obtain at least one second region; and

a first replacement sub-module 333, configured to replace the at least one first region in the original image with the at least one second region, to obtain the transfer image.

In this implementation manner, optionally, as shown in FIG. 3C, the first selection sub-module 331 comprises:

a division unit 3311, configured to divide the original image into M first region(s), wherein M is a natural number; and

a first selection unit 3312, configured to select N first region(s) from the M first region(s), wherein N is a natural number equal to or less than M.

Further, optionally, as shown in FIG. 3D, the first selection unit 3312 comprises:

a detection sub-unit 33121, configured to perform visual significance detection on the original image, to obtain visual significance of the M first region(s); and

a selection sub-unit 33122, configured to select the N first region(s) from P first region(s) of which visual significance is not larger than a significance threshold, wherein P is a natural number equal to or greater than N.

For specific implementation of this implementation manner, reference may be made to corresponding description in the embodiments of an information sending method according to the present application.

In another optional implementation manner, as shown in FIG. 3E, the ambiguity processing module 33 comprises:

a second selection sub-module 334, configured to select at least one first channel from the original image;

a second processing sub-module 335, configured to process the at least one first channel by respectively using the at least one optical ambiguity function, to obtain at least one a second channel; and

a second replacement sub-module 336, configured to replace the at least one first channel in the original image respectively with the at least one second channel, to obtain the transfer image.

In this implementation manner, optionally, as shown in FIG. 3F, the second processing sub-module 335 comprises:

a second selection unit 3351, configured to select at least one first sub-region from the at least one first channel;

a processing unit 3352, configured to process the at least one first sub-region by respectively using the at least one optical ambiguity function, to obtain at least one second sub-region; and

a replacement unit 3353, configured to replace the at least one first sub-region in the at least one first channel respectively with the at least one second sub-region, to obtain at least one second channel.

For specific implementation of this implementation manner, reference may be made to corresponding description in the embodiments of an information sending method according to the present application.

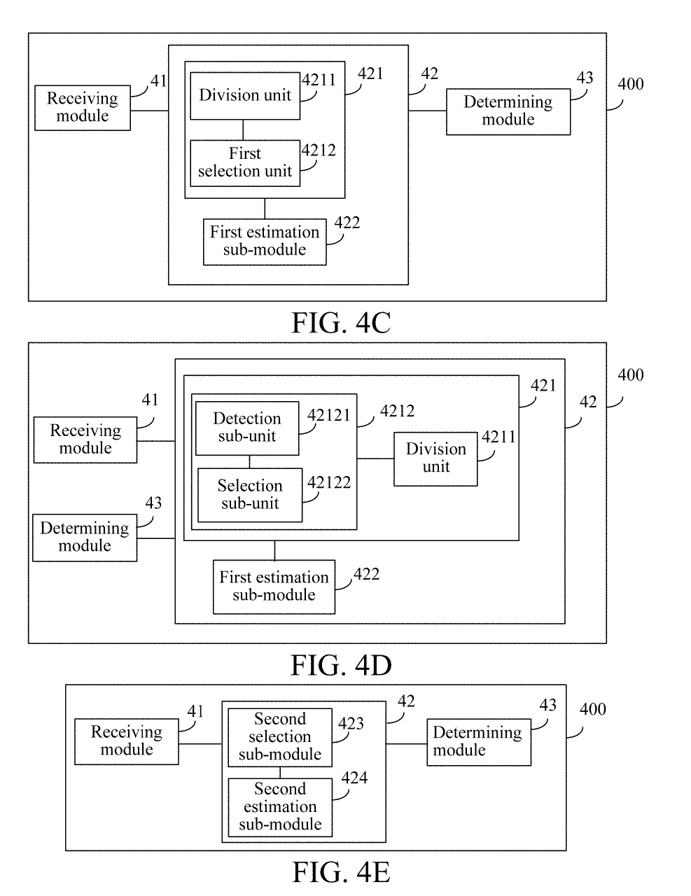

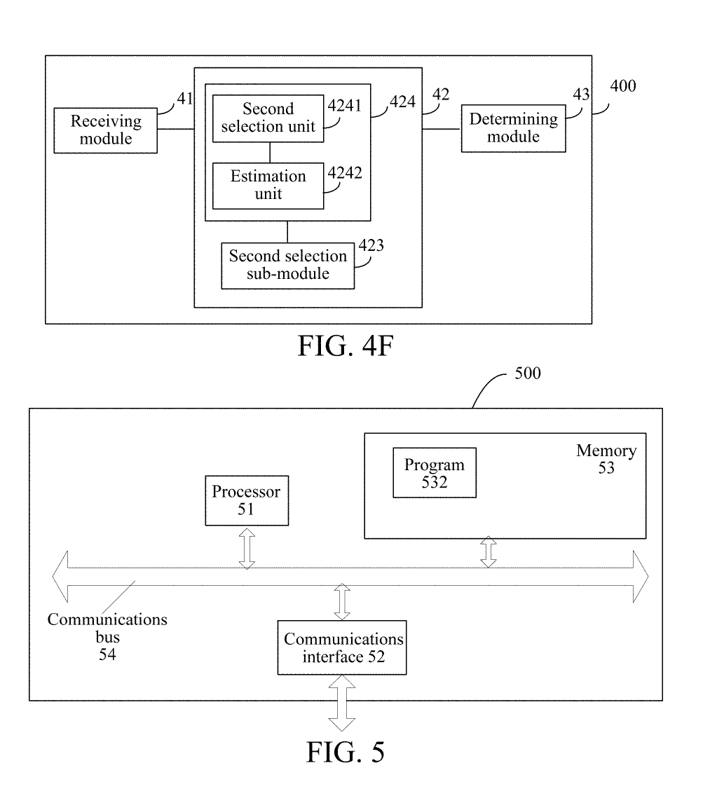

FIG. 4A is a schematic structural diagram of embodiment 1 of an information receiving apparatus according to the present application. As shown in FIG. 4A, an information receiving apparatus (apparatus for short below) 400 comprises:

a receiving module 41, configured to receive a transfer image;

an estimation module 42, configured to perform an optical ambiguity function estimation on the transfer image, to obtain at least one optical ambiguity function of the transfer image; and

a determining module 43, configured to determine information corresponding to the at least one optical ambiguity function.

In this embodiment, the information receiving apparatus 400 may be optionally disposed in a user terminal in a form of software and/or hardware. The user terminal may be, but is not limited to any one of the following: a mobile phone, a computer, and the like.

In this embodiment, each of the at least one optical ambiguity function is function configured to perform optical ambiguity processing on an image, and each of the at least one optical ambiguity function represents an optical ambiguity processing manner. It should be noted that, each of the at least one optical ambiguity function is estimable. That is, after an image is processed by using an optical ambiguity function, an optical ambiguity function estimation can be performed on the processed image, so as to obtain the optical ambiguity function.

Specifically, the at least one optical ambiguity function comprises any one of the following: at least one PSF, and at least one OTF. The PSF is an optical ambiguity function in a space domain form, and the OTF is an optical ambiguity function in a frequency domain form.

Correspondingly, the estimation module 42 is specifically configured to:

perform a PSF estimation on the transfer image, to obtain at least one PSF of the transfer image; or

perform an OTF estimation on the transfer image, to obtain at least one OTF of the transfer image.

In this embodiment, the transfer image is an image obtained after at least one optical ambiguity function processing represented by the at least one optical ambiguity function is performed on an original image. Specifically, when an optical ambiguity function is a PSF, optical ambiguity processing is performed on an original image, specifically, a convolution operation is performed on a space domain signal of the original image with the PSF; when an optical ambiguity function is an OTF, optical ambiguity processing is performed on an original image, specifically, a multiplication operation is performed on a frequency domain signal of the original image with the OTF.

The original image, optionally, is an image shot with a small aperture. The small aperture refers to an aperture size in the case that an aperture F value of a 35 mm camera with a focal length of 50 mm is not smaller than 8, or an equivalent aperture F value of a lens of another specification is not smaller than 8 after equivalent conversion. In a scenario in which the original image is an image shot with a small aperture, a PSF during shooting of the original image approximates to an impulse function. Because a convolution result of an impulse function and any PSF is equal to the PSF, correspondingly, when a convolution operation is performed on the original image with a PSF, the PSF during shooting of the original image has a relatively small effect on a convolution result.

In this embodiment, the information corresponding to the at least one optical ambiguity function is information to be transferred by the transfer image, that is, information that is concealed in the transfer image.

It should be noted that, the information receiving apparatus 400 in this embodiment acts as an information receiver, and a corresponding information sender may be the information sending apparatus in embodiment 1 or embodiment 2 of an information sending apparatus according to the present application.

According to this embodiment, the information receiving apparatus receives a transfer image, performs an optical ambiguity function estimation on the transfer image, to obtain at least one optical ambiguity function of the transfer image, and determines information corresponding to the at least one optical ambiguity function, thus providing a solution for receiving information. Moreover, the information is concealed in the transfer image and only user(s) who knows how the information corresponds to the optical ambiguity function can obtain the concealed information from the transfer image, thus improving security and privacy of information sharing.

The following further describes the apparatus 400 in this embodiment by using some optional implementation manners.

In this embodiment, there are multiple implementation manners for the estimation module 42.

In an optional implementation manner, as shown in FIG. 4B, the estimation module 42 comprises:

a first selection sub-module 421, configured to select at least one region from the transfer image; and

a first estimation sub-module 422, configured to separately perform an optical ambiguity function estimation on the at least one region, to obtain the at least one optical ambiguity function.

In this implementation manner, optionally, as shown in FIG. 4C, the first selection sub-module 421 comprises:

a division unit 4211, configured to divide the transfer image into M region(s), wherein M is a natural number; and

a first selection unit 4212, configured to select N region(s) from the M region(s), wherein N is a natural number equal to or less than M.

Further, optionally, as shown in FIG. 4D, the first selection unit 4212 comprises:

a detection sub-unit 42121, configured to perform visual significance detection on the transfer image, to obtain visual significance of the M region(s); and

a selection sub-unit 42122, configured to select the N region(s) from P region(s) of which visual significance is not larger than a significance threshold, wherein P is a natural number equal to or greater than N.

For specific implementation of this implementation manner, reference may be made to corresponding description in the embodiments of an information receiving method according to the present application.

In another optional implementation manner, as shown in FIG. 4E, the estimation module 42 comprises:

a second selection sub-module 423, configured to select at least one channel from the transfer image; and

a second estimation sub-module 424, configured to perform an optical ambiguity function estimation on the at least one channel, to obtain the at least one optical ambiguity function.

In this implementation manner, optionally, as shown in FIG. 4F, the second estimation sub-module 424 comprises:

a second selection unit 4241, configured to select at least one sub-region from the at least one channel; and

an estimation unit 4242, configured to perform an optical ambiguity function estimation on the at least one sub-region, to obtain the at least one optical ambiguity function.

For specific implementation of this implementation manner, reference may be made to corresponding description in the embodiments of an information receiving method according to the present application.

In this embodiment, there are multiple implementation manners for the determining module 43.

In an optional implementation manner, the information is carried in at least one character; and correspondingly, the determining module 43 is specifically configured to determine, according to a preset corresponding relationship, the at least one character corresponding to the at least one optical ambiguity function.

In this implementation manner, optionally, the determining module 43 is specifically configured to determine, based on each of the at least one optical ambiguity function, that at least one character corresponding to the optical ambiguity function is at least one character corresponding to an optical ambiguity function in the corresponding relationship that is most highly similar to the optical ambiguity function.

In this implementation manner, optionally, the determining module 43 is specifically configured to determine, according to the corresponding relationship, the at least one character that is in one-to-one corresponding relationship with the at least one optical ambiguity function.

For specific implementation of this implementation manner, reference may be made to corresponding description in the embodiments of an information receiving method according to the present application.

FIG. 5 is a schematic structural diagram of embodiment 2 of an information sending apparatus according to the present application. As shown in FIG. 5, an information sending apparatus 500 comprises:

a processor 51, a communications interface 52, a memory 53, and a communications bus 54.

The processor 51, the communications interface 52, and the memory 53 communicate with each other through the communications bus 54.

The communications interface 52 is configured to communicate with an external device such as an information receiver.

The processor 51 is configured to execute a program 532, and specifically, may execute a related step in the foregoing embodiments of the information sending method.

Specifically, the program 532 may comprise a program code. The program code comprises computer operation instructions.

The processor 51 may be a central processing unit (CPU) or an application specific integrated circuit (ASIC), or may be configured as one or more integrated circuits that implement the embodiments of the information sending method.

The memory 53 is configured to store the program 532. The memory 53 may comprise a random access memory (RAM), and may also comprise a non-volatile memory, for example, at least one magnetic disk storage. The program 532 may be specifically configured to enable the information sending apparatus 500 to execute the following steps:

determining to-be-transferred information;

determining at least one optical ambiguity function corresponding to the information;

processing an original image according to the at least one optical ambiguity function, to obtain a transfer image; and

sending the transfer image.

Reference may be made to corresponding description in the corresponding steps and units in the foregoing embodiments of the information sending method for specific implementation of the steps in the program 532, which is not repeated herein.

It should be noted that, the information sending apparatus 500 in this embodiment is used as an information sender, and correspondingly, an information receiver may be the information receiving apparatus in embodiment 1 or embodiment 2 of an information receiving apparatus according to the present application.

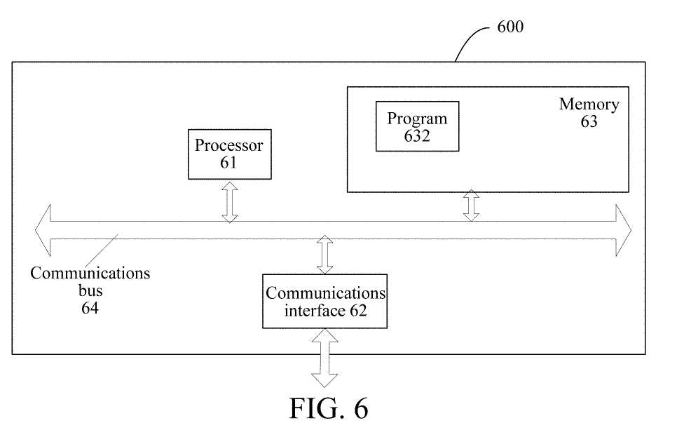

FIG. 6 is a schematic structural diagram of embodiment 2 of an information receiving apparatus according to the present application. As shown in FIG. 6, an information receiving apparatus 600 comprises:

a processor 61, a communications interface 62, a memory 63, and a communications bus 64.

The processor 61, the communications interface 62, and the memory 63 communicate with each other through the communications bus 64.

The communications interface 62 is configured to communicate with an external device such as an information sender.

The processor 61 is configured to execute a program 632, and specifically, may execute a related step in the foregoing embodiments of the information receiving method.

Specifically, the program 632 may comprise a program code. The program code comprises computer operation instructions.

The processor 61 may be a central processing unit (CPU) or an application specific integrated circuit (ASIC), or may be configured as one or more integrated circuits that implement the embodiments of the information receiving method.

The memory 63 is configured to store the program 632. The memory 63 may comprise a high-speed random access memory (RAM), and may also comprise a non-volatile memory, for example, at least one magnetic disk storage. The program 632 may be specifically configured to enable the information receiving apparatus 600 to execute the following steps:

receiving a transfer image;

performing an optical ambiguity function estimation on the transfer image, to obtain at least one optical ambiguity function of the transfer image; and

determining information corresponding to the at least one optical ambiguity function.

Reference may be made to corresponding description in the corresponding steps and units in the foregoing embodiments of the information receiving method for specific implementation of the steps in the program 632, which is not repeated herein.

It should be noted that, the information receiving apparatus 600 in this embodiment is used as an information receiver, and correspondingly, an information sender may be the information sending apparatus in embodiment 1 or embodiment 2 of an information sending apparatus according to the present application.

It can be appreciated by those of ordinary skill in the art that, exemplary units and method steps described with reference to the embodiments disclosed in this specification can be implemented by electronic hardware or a combination of computer software and electronic hardware. Whether these functions are executed by hardware or software depends on specific applications and design constraints of the technical solution. Those skilled in the art may use different methods to implement the described functions for each specific application, but such implementation should not be construed as a departure from the scope of the present application.

If the function is implemented in the form of a software functional unit and is sold or used as an independent product, the product can be stored in a computer-readable storage medium. Based on such understanding, the technical solution of the present application essentially, or the part that contributes to the prior art, or a part of the technical solution may be embodied in the form of a software product; the computer software product is stored in a storage medium and comprises several instructions for enabling a computer device (which may be a personal computer, a server, a network device, or the like) to execute all or some of the steps of the method in the embodiments of the present application. The foregoing storage medium comprises various mediums capable of storing program codes, such as, a USB flash drive, a removable hard disk, a read-only memory (ROM), a random access memory (RAM), a magnetic disk or an optical disc.

The foregoing implementations are only used to describe the present application, but not to limit the present application. Those of ordinary skill in the art can still make various alterations and modifications without departing from the spirit and scope of the present application; therefore, all equivalent technical solutions also fall within the scope of the present application, and the patent protection scope of the present application should be subject to the claims.

1. An information sending method, wherein the method comprises:
determining to-be-transferred information;
determining at least one optical ambiguity function corresponding to the information;
processing an original image according to the at least one optical ambiguity function, to obtain a transfer image; and
sending the transfer image.

2. The method of claim 1, wherein the processing an original image according to the at least one optical ambiguity function, to obtain a transfer image comprises:
selecting at least one first region from the original image;
processing the at least one first region by respectively using the at least one optical ambiguity function, to obtain at least one second region; and
replacing the at least one first region in the original image with the at least one second region, to obtain the transfer image.

3. The method of claim 2, wherein the selecting at least one first region from the original image comprises:
dividing the original image into M first region(s), wherein M is a natural number; and
selecting N first region(s) from the M first region(s), wherein N is a natural number equal to or less than M.

4. The method of claim 3, wherein the selecting N first region(s) from the M first region(s), wherein N is a natural number equal to or less than M comprises:
performing visual significance detection on the original image, to obtain visual significance of the M first region(s); and
selecting the N first region(s) from P first region(s) of which visual significance is not larger than a significance threshold, wherein P is a natural number equal to or greater than N.

5. The method of claim 1, wherein the processing an original image according to the at least one optical ambiguity function, to obtain a transfer image comprises:
selecting at least one first channel from the original image;
processing the at least one first channel by respectively using the at least one optical ambiguity function, to obtain at least one second channel; and
replacing the at least one first channel in the original image with the at least one second channel, to obtain the transfer image.

6. The method of claim 5, wherein the processing the at least one first channel by respectively using the at least one optical ambiguity function, to obtain at least one second channel comprises:
selecting at least one first sub-region from the at least one first channel;
processing the at least one first sub-region by respectively using the at least one optical ambiguity function, to obtain at least one second sub-region; and
replacing the at least one first sub-region in the at least one first channel respectively with the at least one second sub-region, to obtain at least one second channel.

7. The method of claim 1, wherein the information is carried in at least one character; and the determining at least one optical ambiguity function corresponding to the information comprises:
determining, according to a preset corresponding relationship, at least one optical ambiguity function corresponding to the at least one character.

8. The method of claim 7, wherein the determining, according to a preset corresponding relationship, at least one optical ambiguity function corresponding to the at least one character comprises:
determining, according to the corresponding relationship, at least one optical ambiguity function that is in one-to-one corresponding relationship with the at least one character.

9. The method of claim 1, wherein the at least one optical ambiguity function comprises at least one of the following: point spread function (PSF), and one optical transfer function (OTF).

10. An information receiving method, wherein the method comprises:
receiving a transfer image;
performing an optical ambiguity function estimation on the transfer image, to obtain at least one optical ambiguity function of the transfer image; and
determining information corresponding to the at least one optical ambiguity function.

11. The method of claim 10, wherein the performing an optical ambiguity function estimation on the transfer image, to obtain at least one optical ambiguity function of the transfer image comprises:
selecting at least one region from the transfer image; and
separately performing an optical ambiguity function estimation on the at least one region, to obtain the at least one optical ambiguity function.

12. The method of claim 11, wherein the selecting at least one region from the transfer image comprises:
dividing the transfer image into M region(s), wherein M is a natural number; and
selecting N region(s) from the M region(s), wherein N is a natural number equal to or less than M.

13. The method of claim 12, wherein the selecting N region(s) from the M region(s) comprises:
performing visual significance detection on the transfer image, to obtain visual significance of the M region(s); and
selecting the N region(s) from P region(s) of which visual significance is not larger than a significance threshold, wherein P is a natural number equal to or greater than N.

14. The method of claim 10, wherein the performing an optical ambiguity function estimation on the transfer image, to obtain at least one optical ambiguity function of the transfer image comprises:
selecting at least one channel from the transfer image; and
performing an optical ambiguity function estimation on the at least one channel, to obtain the at least one optical ambiguity function.

15. The method of claim 14, wherein the performing an optical ambiguity function estimation on the at least one channel, to obtain the at least one optical ambiguity function comprises:
selecting at least one sub-region from the at least one channel; and
performing an optical ambiguity function estimation on the at least one sub-region, to obtain the at least one optical ambiguity function.

16. The method of claim 10, wherein the information is carried in at least one character; and the determining information corresponding to the at least one optical ambiguity function comprises:
determining, according to a preset corresponding relationship, the at least one character corresponding to the at least one optical ambiguity function.

17. The method of claim 16, wherein the determining, according to a preset corresponding relationship, the at least one character corresponding to the at least one optical ambiguity function comprises:
based on each of the at least one optical ambiguity function, determining that at least one character corresponding to the optical ambiguity function is at least one character corresponding to an optical ambiguity function in the corresponding relationship that is most highly similar to the optical ambiguity function.

18. The method of claim 16, wherein the determining, according to a preset corresponding relationship, the at least one character corresponding to the at least one optical ambiguity function comprises:
determining, according to the corresponding relationship, the at least one character that is in one-to-one corresponding relationship with the at least one optical ambiguity function.

19. The method of claim 10, wherein the at least one optical ambiguity function comprises at least one of the following: one point spread function (PSF), and one optical transfer function (OTF).

20. An information sending apparatus, wherein the apparatus comprises:
a first determining module, configured to determine to-be-transferred information;
a second determining module, configured to determine at least one optical ambiguity function corresponding to the information;
a ambiguity processing module, configured to process an original image according to the at least one optical ambiguity function, to obtain a transfer image; and
a sending module, configured to send the transfer image.

21. The apparatus of claim 20, wherein the ambiguity processing module comprises:
a first selection sub-module, configured to select at least one first region from the original image;
a first processing sub-module, configured to process the at least one first region by respectively using the at least one optical ambiguity function, to obtain at least one second region; and
a first replacement sub-module, configured to replace the at least one first region in the original image with the at least one second region, to obtain the transfer image.

22. The apparatus of claim 21, wherein the first selection sub-module comprises:
a division unit, configured to divide the original image into M first region(s), wherein M is a natural number; and
a first selection unit, configured to select N first region(s) from the M first region(s), wherein N is a natural number equal to or less than M.

23. The apparatus of claim 22, wherein the first selection unit comprises:
a detection sub-unit, configured to perform visual significance detection on the original image, to obtain visual significance of the M first region(s); and
a selection sub-unit, configured to select the N first region(s) from P first region(s) of which visual significance is not larger than a significance threshold, wherein P is a natural number equal to or greater than N.

24. The apparatus of claim 20, wherein the ambiguity processing module comprises:
a second selection sub-module, configured to select at least one first channel from the original image;
a second processing sub-module, configured to process the at least one first channel by respectively using the at least one optical ambiguity function, to obtain at least one second channel; and
a second replacement sub-module, configured to replace the at least one first channel in the original image with the at least one second channel, to obtain the transfer image.

25. The apparatus of claim 24, wherein the second processing sub-module comprises:
a second selection unit, configured to select at least one first sub-region from the at least one first channel;
a processing unit, configured to process the at least one first sub-region by respectively using the at least one optical ambiguity function, to obtain at least one second sub-region; and
a replacement unit, configured to replace the at least one first sub-region in the at least one first channel respectively with the at least one second sub-region, to obtain at least one second channel.

26. The apparatus of claim 20, wherein the information is carried in at least one character; and the second determining module is specifically configured to determine, according to a preset corresponding relationship, at least one optical ambiguity function corresponding to the at least one character.

27. The apparatus of claim 26, wherein the second determining module is specifically configured to determine, according to the corresponding relationship, at least one optical ambiguity function that is in one-to-one corresponding relationship with the at least one character.

28. The apparatus of claim 20, wherein the at least one optical ambiguity function comprises at least one of the following: one point spread function (PSF), and one optical transfer function (OTF).

29. An information receiving apparatus, wherein the apparatus comprises:
a receiving module, configured to receive a transfer image;
an estimation module, configured to perform an optical ambiguity function estimation on the transfer image, to obtain at least one optical ambiguity function of the transfer image; and
a determining module, configured to determine information corresponding to the at least one optical ambiguity function.

30. The apparatus of claim 29, wherein the estimation module comprises:
a first selection sub-module, configured to select at least one region from the transfer image; and
a first estimation sub-module, configured to separately perform an optical ambiguity function estimation on the at least one region, to obtain the at least one optical ambiguity function.

31. The apparatus of claim 30, wherein the first selection sub-module comprises:
a division unit, configured to divide the transfer image into M region(s), wherein M is a natural number; and
a first selection unit, configured to select N region(s) from the M region(s), wherein N is a natural number equal to or less than M.

32. The apparatus of claim 31, wherein the first selection unit comprises:
a detection sub-unit, configured to perform visual significance detection on the transfer image, to obtain visual significance of the M region(s); and
a selection sub-unit, configured to select the N region(s) from P region(s) of which visual significance is not larger than a significance threshold, wherein P is a natural number equal to or greater than N.

33. The apparatus of claim 29, wherein the estimation module comprises:
a second selection sub-module, configured to select at least one channel from the transfer image; and
a second estimation sub-module, configured to perform an optical ambiguity function estimation on the at least one channel, to obtain the at least one optical ambiguity function.

34. The apparatus of claim 33, wherein the second estimation sub-module comprises:
a second selection unit, configured to select at least one sub-region from the at least one channel; and
an estimation unit, configured to perform an optical ambiguity function estimation on the at least one sub-region, to obtain the at least one optical ambiguity function.

35. The apparatus of claim 29, wherein the information is carried in at least one character; and the determining module is specifically configured to determine, according to a preset corresponding relationship, the at least one character corresponding to the at least one optical ambiguity function.

36. The apparatus of claim 35, wherein the determining module is specifically configured to: based on each of the at least one optical ambiguity function, determine that at least one character corresponding to the optical ambiguity function is at least one character corresponding to an optical ambiguity function in the corresponding relationship that is most highly similar to the optical ambiguity function.

37. The apparatus of claim 35, wherein the determining module is specifically configured to determine, according to the corresponding relationship, the at least one character that is in one-to-one corresponding relationship with the at least one optical ambiguity function.

38. The apparatus of claim 29, wherein the at least one optical ambiguity function comprises at least one of the following: one point spread function (PSF), and one optical ambiguity function (OTF).

39. A non-transitory computer-readable medium comprising executable instructions that, in response to execution, cause a device comprising a processor to perform operations, comprising:
determining to-be-transferred information;
determining at least one optical ambiguity function corresponding to the information;
processing an original image according to the at least one optical ambiguity function, to obtain a transfer image; and
sending the transfer image.

40. A non-transitory computer-readable medium comprising executable instructions that, in response to execution, cause a device comprising a processor to perform operations, comprising:
receiving a transfer image;
performing an optical ambiguity function estimation on the transfer image, to obtain at least one optical ambiguity function of the transfer image; and
determining information corresponding to the at least one optical ambiguity function.
